(19) United States
(12) Patent Application Publication
(10) Pub. No.: US 2021/0284479 A1
(43) Pub. Date: Sep. 16, 2021

(54) SHEET PROCESSING APPARATUS AND IMAGE FORMING SYSTEM

(71) Applicant: CANON KABUSHIKI KAISHA, TOKYO (JP)

(72) Inventor: Jun Haruna, Shizuoka (JP)

(21) Appl. No.: 17/180,982

(22) Filed: Feb. 22, 2021

(30) Foreign Application Priority Data
Mar. 11, 2020 (JP) 2020-042347

(51) Int. Cl. B65H 35/00; B26D 5/28; B26F 1/04; B65H 43/00

(52) U.S. Cl. CPC B65H 35/0073; B26D 5/28; B26F 1/04; B65H 2801/27; B65H 2511/22; B65H 2513/51; B65H 43/00

(57) ABSTRACT

A sheet processing apparatus includes a conveyance unit, a punch member configured to be rotatably supported and punch a hole at a predetermined position, a sensor, a driving source configured to rotatably drive the punch member, and a control unit configured to control the driving source. The control unit is configured to (1) control the driving source based on a punching gap distance between a last punching position of a preceding sheet and a first punching position of a succeeding sheet in the sheet conveyance direction, and a rotational position of the punch member, and (2) perform an avoidance process of avoiding a punching process of punching the hole in the succeeding sheet in a case where the control unit judges not to perform the punching process in the succeeding sheet when the succeeding sheet has reached the detection position.

### BACKGROUND OF THE INVENTION

### Field of the Invention

The present invention relates to a sheet processing apparatus which processes a sheet, and an image forming system including the sheet processing apparatus.

### Description of the Related Art

Hitherto, a finisher which is coupled to an image forming apparatus such as a printer, and performs a punching process in a sheet discharged from the image forming apparatus is suggested (refer to Japanese Patent Laid-Open No. H10-279170). This finisher includes a sheet detection sensor detecting the sheet, a conveyance roller pair conveying the sheet, and a punching unit punching a hole in the sheet conveyed by the conveyance roller pair. The punching unit includes a punch and a die each supported by a casing, and a punch drive motor driving the punch and the die synchronously.

The punch and the die are stopping and waiting at a home position, and started to be driven by the punch drive motor based on a detection result of the sheet detection sensor which has detected a trailing edge of the sheet. Then, the punch and the die engage with each other at a predetermined position in a part of the trailing edge of the sheet, and punch the hole in the sheet conveyed by the conveyance roller pair.

Recently, for the image forming apparatus, it is demanded to shorten a gap distance between the trailing edge of a preceding sheet and a leading edge of the succeeding sheet (hereinafter referred to as a sheet gap distance) and improve productivity. For example, an acceleration/deceleration control of the punch drive motor is known as a method to shorten the sheet gap distance. However, in a case where a variation of a sheet conveyance and the like exceeds a controllable range of the acceleration/deceleration control of the punch drive motor, a low accuracy punching not intended by a user is performed.

### SUMMARY OF THE INVENTION

According to one aspect of the present invention, a sheet processing apparatus includes a conveyance unit configured to convey a sheet in a sheet conveyance direction, a punch member configured to be rotatably supported and punch a hole at a predetermined position in the sheet being conveyed by the conveyance unit, a sensor configured to change an output value based on presence/absence of the sheet at a detection position positioned upstream of the punch member in the sheet conveyance direction, a driving source configured to rotatably drive the punch member, and a control unit configured to control the driving source, wherein the control unit is configured to (1) control the driving source based on a punching gap distance between a last punching position of a preceding sheet and a first punching position of a succeeding sheet in the sheet conveyance direction, and a rotational position of the punch member, and (2) perform an avoidance process of avoiding a punching process of punching the hole in the succeeding sheet in a case where the control unit judges not to perform the punching process in the succeeding sheet based on the punching gap distance and the rotational position of the punch member when the succeeding sheet has reached the detection position.

Further features of the present invention will become apparent from the following description of exemplary embodiments with reference to the attached drawings.

### BRIEF DESCRIPTION OF THE DRAWINGS

FIG. 1 is a diagram showing a schematic general view of an image forming apparatus according to a first embodiment.

FIG. 2A is a diagram showing a schematic view of a punch and a die positioned at a home position.

FIG. 2B is a diagram showing a schematic view of the punch and the die positioned at an engagement position.

FIG. 2C is a diagram showing a schematic view of the punch and the die positioned at a position at an end of punching a hole.

FIG. 3 is a block diagram showing a configuration of hardware of an image forming system.

FIG. 4 is a block diagram showing a configuration of functions of the image forming system.

FIG. 5 is a flowchart showing a punching control.

FIG. 6A is a flowchart showing a judgement regarding whether or not it is possible to punch the hole.

FIG. 6B is a flowchart showing the other judgement regarding whether or not it is possible to punch the hole.

FIG. 7 is a block diagram showing a configuration of hardware according to a second embodiment.

FIG. 8 is a block diagram showing a configuration of functions according to the second embodiment.

FIG. 9 is a flowchart showing a punching control.

FIG. 10A is a plan view explaining a movement of a punching apparatus to an A4 size sheet.

FIG. 10B is a plan view explaining the movement of the punching apparatus to an A5 size sheet

### DESCRIPTION OF THE EMBODIMENTS

Hereinafter, exemplary embodiments to put into practice this disclosure will be described with reference to attached drawings.

### First Embodiment

### General Configuration

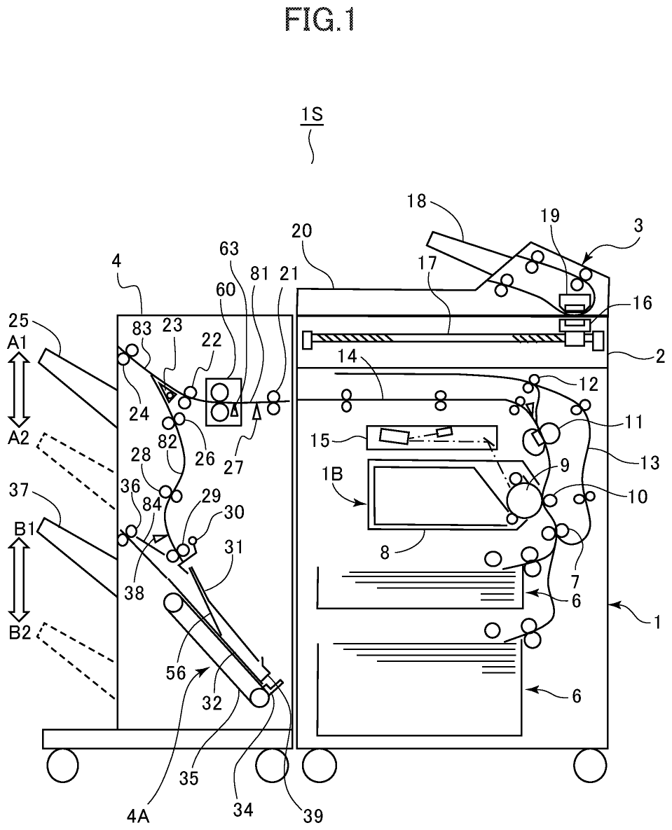

As shown in FIG. 1, an image forming system 1S according to a first embodiment is constituted by an image forming apparatus 1, an image reading apparatus 2, a document feeding apparatus 3, and a sheet processing apparatus 4. The image forming system 1S forms an image on a sheet, which is a recording material, and outputs the sheet after processing the sheet by the sheet processing apparatus 4 as needed. Hereinafter, operation of each apparatus will be described simply, and thereafter the sheet processing apparatus 4 will be described in detail.

The document feeding apparatus 3 conveys a document placed on a document tray 18 to image reading units 16 and 19. Each of the image reading units 16 and 19 is an image sensor which reads image information from a surface of the document, and both surfaces of the document are read by feeding the document once. The document whose image information has been read is discharged to a document discharge portion 20. Further, by reciprocally moving the image reading unit 16 by a drive unit 17, the image reading apparatus 2 is capable of reading the image information from a standstill document (including the document, such as a booklet document, for which the document feeding apparatus 3 is unusable) placed on a platen glass.

The image forming apparatus 1 is an electrophotographic apparatus including an image forming unit 1B of a direct transfer system. The image forming unit 1B includes a cartridge 8 including a photosensitive drum 9, and a laser scanner unit 15 disposed above the cartridge 8. In a case where an image forming operation is performed, a surface of the rotating photosensitive drum 9 is charged, and an electrostatic latent image is written on the surface of the drum by the laser scanner unit 15 which exposes the photosensitive drum 9 based on the image information. The electrostatic latent image carried on the photosensitive drum 9 is developed to a toner image by charged toner particles, and the toner image is conveyed to a transfer portion where the photosensitive drum 9 and a transfer roller 10 are facing each other. A controller of the image forming apparatus 1 performs the image forming operation based on the image information read by the image reading units 16 and 19 or image information received from an outside computer via a network.

The image forming apparatus 1 includes a plurality of feeding units 6 to feed the sheet, which is a recording material, one by one at predetermined intervals. After a skew of the sheet fed by the feeding units 6 has been corrected by a registration roller pair 7, the sheet is conveyed to the transfer portion, and the toner image carried on the photosensitive drum 9 is transferred to the sheet at the transfer portion. A fixing unit 11 is disposed downstream of the transfer portion in a sheet conveyance direction. The fixing unit 11 includes a rotary member pair, which nips and conveys the sheet, and a heating element, such as a halogen lamp, to heat the toner image, and performs a fixing process of the image by heating and pressing the toner image on the sheet.

In a case where the sheet on which an image formation has been performed is discharged outside the image forming apparatus 1, the sheet passed through the fixing unit 11 is conveyed to the sheet processing apparatus 4 via a horizontal conveyance unit 14. In a duplex printing, in a case of the sheet on which the image formation on a first surface has been completed, the sheet passed through the fixing unit 11 is delivered to a reverse conveyance roller pair 12, and conveyed by the reverse conveyance roller pair 12 in a manner of switch-back conveyance, and conveyed to the registration roller pair 7 again via a re-conveyance unit 13. Then, after the image has been formed on a second surface by being passed through the transfer portion and the fixing unit 11 again, the sheet is conveyed to the sheet processing apparatus 4 via the horizontal conveyance unit 14.

The image forming unit 1B described above is an example of the image forming unit which forms the image on the sheet, and it is acceptable to use the electrophotographic unit of an intermediate transfer system which transfers the toner image formed on a photosensitive member to the sheet via an intermediate transfer member. Further, it is acceptable to use a printing unit of an ink jet system or an offset printing system for the image forming unit.

### Sheet Processing Apparatus

The sheet processing apparatus 4 includes a punching apparatus 60 which performs a punching process in the sheet, and, having performed the punching process, discharges the sheet received from the image forming apparatus 1 in a form of a sheet bundle. Further, the sheet processing apparatus 4 is also capable of simply discharging the sheet received from the image forming apparatus 1 without performing the punching process.

In the sheet processing apparatus 4, as conveyance paths to convey the sheet, a receiving path 81, an internal discharge path 82, a first discharge path 83, and a second discharge path 84 are provided, and, as discharge destinations to discharge the sheet, an upper sheet discharge tray 25 and a lower sheet discharge tray 37 are provided. The receiving path 81, serving as a first conveyance path, is the conveyance path which guides the sheet received from the image forming apparatus 1, and the internal discharge path 82, serving as a second conveyance path, is the conveyance path which extends below the receiving path 81 and guides the sheet toward an alignment unit 4A. The first discharge path 83 is the conveyance path which discharges the sheet to the upper sheet discharge tray 25, and the second discharge path 84, serving as a third conveyance path, is the conveyance path which extends toward a bundle discharge roller pair 36 from an intermediate stacking unit 39 and guides the sheet to the bundle discharge roller pair 36.

The sheet discharged from the horizontal conveyance unit 14 of the image forming apparatus 1 is received by an inlet roller pair 21, serving as a conveyance unit disposed on the receiving path 81, and conveyed to a before-inversion roller pair 22 via the receiving path 81. The punching apparatus 60 is disposed between the inlet roller pair 21 and the before-inversion roller pair 22 in a sheet conveyance direction, and the punching process is performed in the sheet conveyed on the receiving path 81 by the punching apparatus 60, described later. Further, an inlet sensor 27 changes an output value (for example, a voltage value and an output signal) based on presence and absence of the sheet at a second detection position between the inlet roller pair 21 and the before-inversion roller pair 22. The inlet sensor 27, serving as a second sensor, is positioned upstream of a before-punch sensor 63, described later, in the conveyance direction. The before-inversion roller pair 22 conveys the sheet received from the inlet roller pair 21 toward the first discharge path 83.

To be noted, it is acceptable to set a sheet conveyance speed by the inlet roller pair 21 larger than the sheet conveyance speed by the horizontal conveyance unit 14, and accelerate the sheet conveyance speed after the inlet roller pair 21 has received the sheet. In this case, it is suitable that, by providing a one-way clutch between conveyance rollers of the horizontal conveyance unit 14 and a motor which drives the conveyance rollers, the conveyance rollers are configured to idle even if the sheet is dragged by the inlet roller pair 21.

In a case where the discharge destination of the sheet is the upper sheet discharge tray 25, an inversion roller pair 24 discharges the sheet received from the before-inversion roller pair 22 to the upper sheet discharge tray 25. In a case where the discharge destination of the sheet is the lower sheet discharge tray 37, the inversion roller pair 24, serving as a reverse portion, conveys the sheet to internal discharge path 82 by inverting the sheet received from the before-inversion roller pair 22 and carrying out the switch-back conveyance. A check valve 23 is disposed at a branch portion, which is positioned upstream of the inversion roller pair 24 in the sheet conveyance direction by the inversion roller pair 24, of the receiving path 81 and the internal discharge path 82 from the first discharge path 83. The check valve 23 is capable of regulating a reverse flow of the sheet, whose switch-back conveyance has been carried out by the inversion roller pair 24, to the receiving path 81.

An internal discharge roller pair 26, an intermediate conveyance roller pair 28, and a kick-out roller pair 29, serving as rotary member pairs disposed on the internal discharge path 82, convey the sheet received from the inversion roller pair 24 toward the alignment unit 4A while receiving and delivering the sheet in sequence. A before-intermediate stacking sensor 38 detects the sheet between the intermediate conveyance roller pair 28 and the kick-out roller pair 29. For the inlet sensor 27, the before-punch sensor 63, and the before-intermediate stacking sensor 38, for example, an optical sensor using light to detect the presence and absence of the sheet at a detection position and a flag sensor using a flag to be pressed on the sheet are used.

The alignment unit 4A includes a bundle pressing flag 30, the intermediate stacking unit 39, serving as a stacking unit, a bundle discharge guide 34, and a driving belt 35. The intermediate stacking unit 39 is constituted by an intermediate upper guide 31 and an intermediate lower guide 32, and stacks a plurality of sheets as a sheet bundle. The sheet bundle discharged toward the intermediate stacking unit 39 by the kick-out roller pair 29 is pressed on the intermediate lower guide 32 by the bundle pressing flag 30.

Then, the sheet bundle discharged to the intermediate stacking unit 39 is guided downwards along the intermediate lower guide 32, and aligned by a longitudinal alignment plate provided at a downstream edge of the intermediate stacking unit 39 in the sheet conveyance direction. Further, the sheet bundle aligned in the sheet conveyance direction by the longitudinal alignment plate is aligned in a width direction orthogonal to the sheet conveyance direction by a lateral alignment plate, not shown. Having provided with the alignment processes as described above, the sheet bundle is pushed out by the bundle discharge guide 34 secured to the driving belt 35, and delivered to the bundle discharge roller pair 36 via the second discharge path 84. The sheet bundle is discharged outside the apparatus by the bundle discharge roller pair 36, serving as a discharge unit, and stacked on the lower sheet discharge tray 37.

Both of the upper and lower sheet discharge trays 25 and 37 are movable in a vertical direction with respect to a casing of the sheet processing apparatus 4. The sheet processing apparatus 4 includes sheet surface detection sensors which detect positions of upper surfaces of the sheets (stacking heights of the sheets) on the upper and lower sheet discharge trays 25 and 37, and, when either one of the sensors detects the sheet, a corresponding tray is lowered in directions A2 and B2. Further, when the sheet surface detection sensors detect that the sheet on the upper sheet discharge tray 25 or the lower sheet discharge tray 37 has been taken out, the corresponding tray is lifted in directions A1 and B1. Accordingly, an ascent and descent of the upper and lower sheet discharge trays 25 and 37 are controlled so that the positions of the upper surfaces of the sheets stacked on the trays are kept at a constant.

### Punching Apparatus

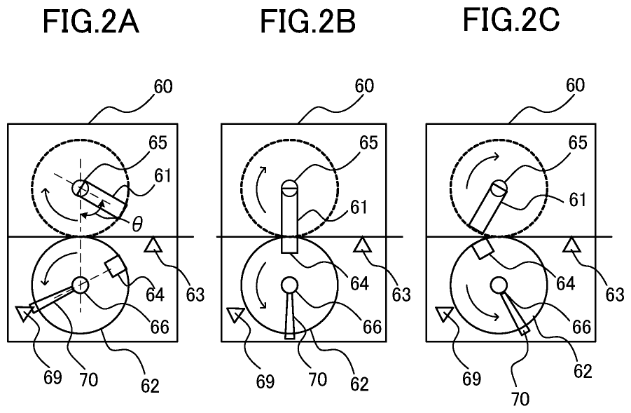

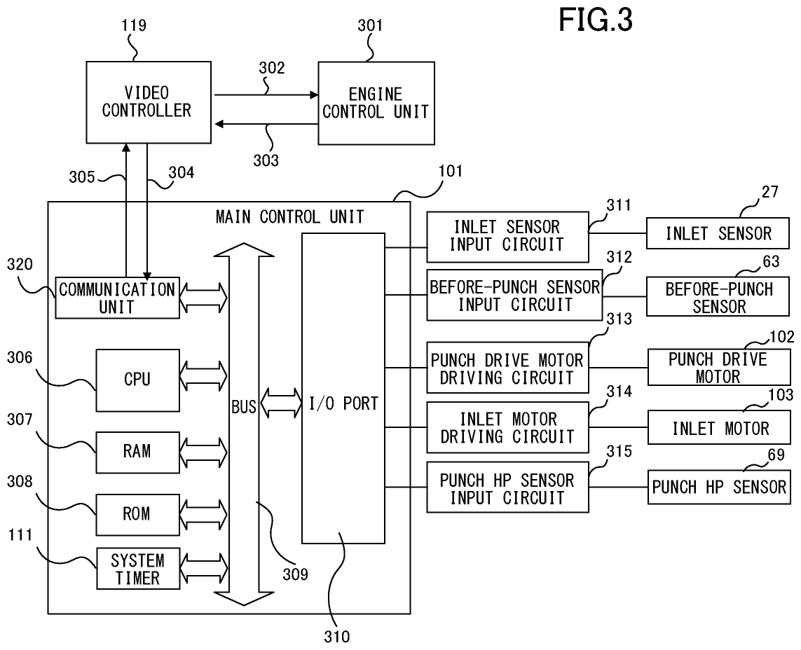

Next, the punching apparatus 60 will be described. The punching apparatus 60 is a punching apparatus of a rotary method which punches a hole in the sheet by a rotating punch. As shown in FIG. 2A, the punching apparatus 60 includes a punch 61 which is rotatably supported by a punch shaft 65 as a center, a die 62 which rotates around a die shaft 66 as a center, a punch home position (HP) sensor 69, and a punch HP flag 70. The die 62 includes a die hole 64 which is capable of engaging with the punch 61, and the punch shaft 65 and the die shaft 66 engage with a gear, not shown, which is driven by a punch drive motor 102 (refer to FIG. 3). In FIG. 2A, by driving the punch drive motor 102, serving as a driving source, the punch 61, serving as a punch member, is rotatably driven in a clockwise direction, and the die 62 is rotatably driven in a counterclockwise direction. Further, the punch HP flag 70 rotates in an interlocking manner with the die shaft 66.

The before-punch sensor 63, serving as a sensor and a first sensor, detects the sheet at a first detection position which is positioned upstream of the punch 61 and the die 62 in the conveyance direction. In more particular, since the before-punch sensor 63 changes an output value (for example, a voltage value and an output signal) based on presence and absence of the sheet at the first detection position, the output value is changed when the leading and trailing edges of the sheet pass through the first detection position.

FIG. 2A is a diagram showing a schematic view of the punch 61 and the die 62 positioned at a home position. The punch 61 and the die 62 are positioned at the home position at a start and end of an image forming job to form the image on the sheet, and are stopping at the home position during a time when the job is not input. At the home position, the punch 61 and the die 62 are disposed so as not to interrupt the conveyance of the sheet. Further, the home position of the punch 61 is a position at which the punch 61 is rotated upstream of an engagement position of the punch 61 and the die 62 by an angle θ. The home position of the punch 61 is recognized by a detection of the punch HP flag 70 with the punch HP sensor 69, serving as a rotational position detection sensor.

FIG. 2B is a diagram showing a schematic view of the punch 61 and the die 62 positioned at the engagement position. When the punch 61 and the die 62 are positioned at the engagement position, the punch 61 engages with the die hole 64 and the hole is punched in the sheet. FIG. 2C is a diagram showing a schematic view of the punch 61 and the die 62 positioned at a punching end position.

As described above, the punch 61 and the die 62 wait at the home position, and are started to be driven at a predetermined timing by the punch drive motor 102 based on the detection of the leading edge of the sheet by the before-punch sensor 63. At this time, the punch drive motor 102 is controlled so that peripheral speeds of the punch 61 and the die 62 are equalized with the conveyance speed of the sheet, and wrinkling and tearing of the sheet at punching is prevented. The punch 61 and the die 62 are separated from the punched sheet at the punching end position.

### Configuration of Hardware

FIG. 3 is a block diagram showing a configuration of hardware of the image forming system 1S. To be noted, FIG. 3 shows a configuration of the sheet processing apparatus 4 primarily relating to a control of this embodiment, and the other configurations are omitted.

As shown in FIG. 3, the image forming system 1S includes a main control unit 101, a video controller 119, and an engine control unit 301, and the video controller 119 integrates the image forming apparatus 1 and the sheet processing apparatus 4. The engine control unit 301 controls the image forming apparatus 1, and the main control unit 101 controls the sheet processing apparatus 4.

The video controller 119 is coupled to the engine control unit 301 and the main control unit 101 via serial command transmission signal lines 302 and 304, respectively, and transmits a command to these engine control unit 301 and main control unit 101 by a serial communication. The engine control unit 301 is coupled to the video controller 119 via a serial status transmission signal line 303, and transmits status data to the video controller 119 by the serial communication. The main control unit 101, serving as a control unit, is coupled to the video controller 119 via a serial status transmission signal line 305, and transmits the status data to the video controller 119 by the serial communication.

When the image forming operation is performed, the video controller 119 carries out a control by transmitting the serial command to the engine control unit 301 and the main control unit 101, and receiving the status data from the engine control unit 301 and the main control unit 101. As described above, in a case where a plurality of apparatuses are operated by being coupled to each other, the video controller 119 centrally controls the control and status of each apparatus, and maintains alignment of the operation among each apparatus.

The main control unit 101 includes a central processing unit (CPU) 306, a random-access memory (RAM) 307, a read-only memory (ROM) 308, a system timer 111, a communication unit 320, an input/output (I/O) port 310, and the like. The CPU 306 is a central arithmetic unit to control various operation of the sheet processing apparatus 4. The RAM 307 is a volatile memory to temporarily store control data required for the operation of sheet processing apparatus 4. The ROM 308 is a nonvolatile memory to store programs and control tables required for the operation of sheet processing apparatus 4.

The system timer 111 generates timing required for various controls, and the communication unit 320 performs a communication process with the video controller 119. These CPU 306, RAM 307, ROM 308, system timer 111, and communication unit 320 are coupled to the I/O port 310 via a bus 309, and the I/O port 310 inputs and outputs a control signal to various units of the sheet processing apparatus 4. In more particular, the I/O port 310 is coupled to the inlet sensor 27 and the before-punch sensor 63 via an inlet sensor input circuit 311 and a before-punch sensor input circuit 312, respectively. Further, the I/O port 310 is coupled to the punch drive motor 102 and an inlet motor 103 via a punch drive motor driving circuit 313 and an inlet motor driving circuit 314, respectively. The inlet motor 103 drives the inlet roller pair 21. Further, the I/O port 310 is coupled to the punch HP sensor 69 via a punch HP sensor input circuit 315.

### Configuration of Functions

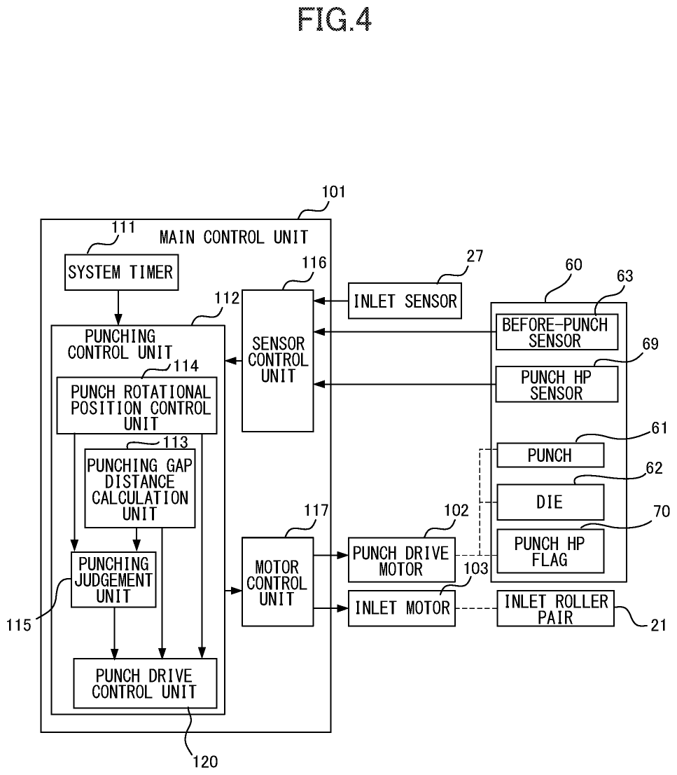

FIG. 4 is a block diagram showing a configuration of functions of the image forming system 1S. To be noted, FIG. 4 shows only the functions extracted as primarily relating to a control of punching the hole in the sheet of this embodiment, and the other functions are omitted herein.

The main control unit 101 includes, as shown in FIG. 4, the system timer 111, a punching control unit 112, a sensor control unit 116, and a motor control unit 117, and controls the conveyance and the punching in the image forming system 1S. The inlet sensor 27, and the before-punch sensor 63 and the punch HP sensor 69 of the punching apparatus 60 input a signal to the sensor control unit 116. The sensor control unit 116 outputs information relating to the presence and absence of the sheet at each detection position and the information relating to the position of the punch 61 to the punching control unit 112. By controlling the motor control unit 117, the punching control unit 112 drives the punch drive motor 102, which drives the punch 61, the die 62, and the punch HP flag 70, and the inlet motor 103, which drives the inlet roller pair 21.

The punching control unit 112 includes a punching gap distance calculation unit 113, a punch rotational position control unit 114, a punching judgement unit 115, and a punch drive control unit 120. The punching control unit 112 detects a sheet gap distance, which is a distance between a preceding sheet and a succeeding sheet, based on time when the leading and trailing edges of the sheet pass through the detection positions of the inlet sensor 27 and the before-punch sensor 63. Further, the punching control unit 112 stores the time when the inlet sensor 27 has detected the leading edge of the sheet.

The punching gap distance calculation unit 113 calculates a punching gap distance which is a gap distance between the last punching position of the preceding sheet and the first punching position of the succeeding sheet in the sheet conveyance direction. To be noted, in a case where a plurality of holes are punched in the same sheet, gap distances between the holes and positions of these plurality of holes (hereinafter referred to as predetermined punching position information) are predetermined by a specification. The predetermined punching position information is received from the controller. For example, in a case where two holes are punched in the same A4 size sheet, the gap distance between these holes is 80 mm, and in a case where three holes (North America 3 holes) are punched in the same letter (LTR) size sheet, the gap distance between these holes is 108 mm. The punching gap distance described above is calculated from the sheet gap distance, the predetermined punching position information, a distance from the leading edge or the trailing edge of the sheet to the punching position, and the like.

The punch rotational position control unit 114 controls information relating to a rotational position of the punch 61 (hereinafter referred to as punch rotational position information) from drive step information of the punch drive motor 102 and information from the punch HP sensor 69. The punch rotational position information is estimated using the home position of the punch 61 detected by the punch HP sensor 69 as a starting point. The punching judgement unit 115 judges based on the punch rotational position information, the punching gap distance, and control range information of each motor whether or not it is possible to punch the hole at a desired position in the succeeding sheet, and notifies a result to the punch drive control unit 120. The rotational position of the punch 61 is the position of the punch 61 in a rotational direction around the punch shaft 65 as the center with respect to the home position of the punch 61 (refer to FIG. 2A). To be noted, it is acceptable to detect the rotational position of the punch 61 using an encoder, a potentiometer, and the like, not using the punch HP sensor 69.

The punch drive control unit 120 performs a control by accelerating and decelerating a movement of the punch drive motor 102 based on the result of the punching judgement made by the punching judgement unit 115, the calculated punching gap distance, the punch rotational position information, and the information from the before-punch sensor 63. Then, the punch drive control unit 120 stops punching the hole in the sheet by stopping the punch drive motor 102, or performs punching the hole in the sheet by continuing to drive the punch drive motor 102.

Further, the punching control unit 112 performs a rotational control of the punch 61 and a conveyance control of the sheet based on the positional information on the sheet detected by each sensor, which is received from the sensor control unit 116, and the punch rotational position information which is controlled by the punch rotational position control unit 114. At this time, the punching control unit 112 drives each motor in a predetermined timing using the system timer 111, a number of driving steps of the motor controlled by the motor control unit 117, and the like, while monitoring the positional information on the sheet at each sensor.

### Punching Control

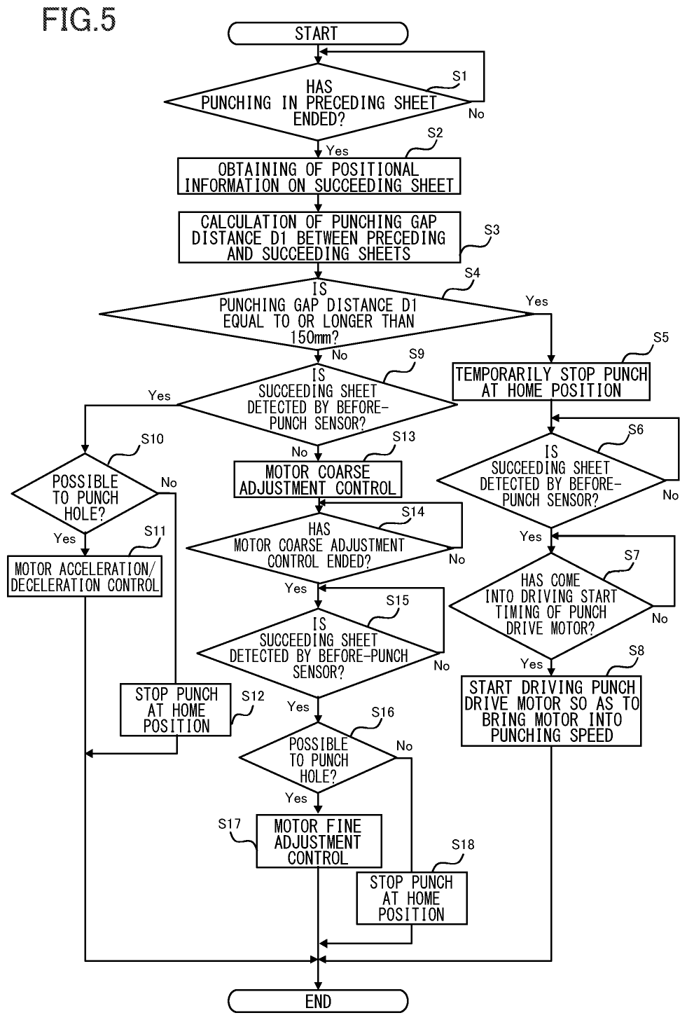

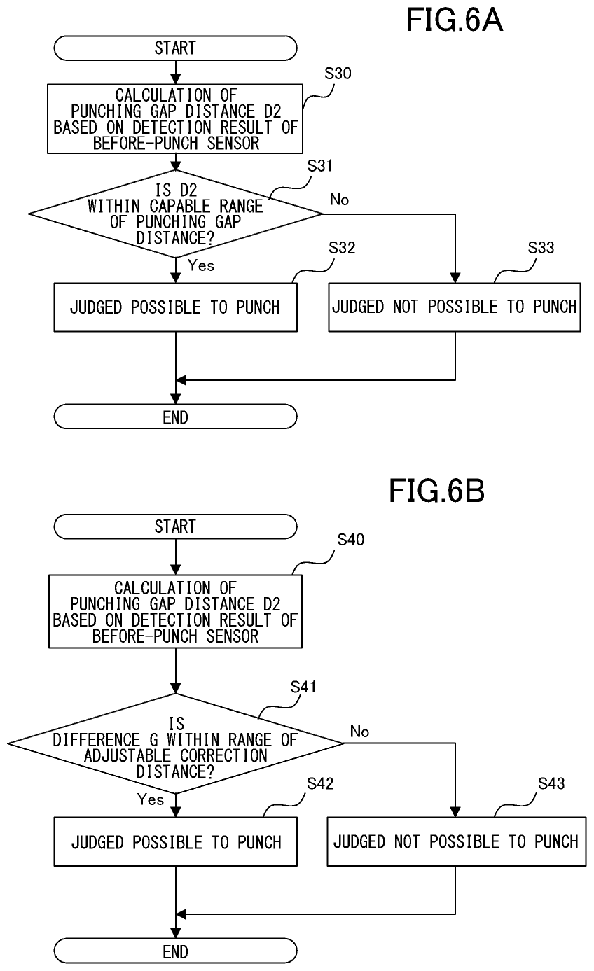

Next, with reference to FIGS. 5 to 6B, the punching control to successively punch the holes in a plurality of sheets will be described. As shown in FIG. 5, when the punching control is started, the main control unit 101 judges whether or not the punching of the preceding sheet has ended (STEP S1). The end of the punching is judged based on having been positioned of the punch 61 at the engagement position by the punch drive motor 102.

In a case where it is judged that the punching of the preceding sheet has ended (STEP S1: YES), the main control unit 101 obtains the positional information on the succeeding sheet (STEP S2). The positional information on the succeeding sheet is obtained based on the detection result of the inlet sensor 27. That is, in a case where the inlet sensor 27 has already detected the leading edge of the succeeding sheet at the end of punching the hole in the preceding sheet, the positional information is obtained from a timing in which the inlet sensor 27 has turned into ON. In a case where the inlet sensor 27 has not detected the leading edge of the succeeding sheet at the end of punching the hole in the preceding sheet, it is judged that there is an adequate distance between the preceding sheet and the succeeding sheet.

Then, the main control unit 101 calculates a punching gap distance D1 between the preceding sheet and the succeeding sheet based on the positional information on the succeeding sheet obtained at STEP S2 (STEP S3). That is, the punching gap distance D1, calculated based on the detection result of the inlet sensor 27, is the gap distance between the last punching position in the preceding sheet and the first punching position in the succeeding sheet in the sheet conveyance direction. The calculation of the punching gap distance D1 is performed by the punching gap distance calculation unit 113 of the main control unit 101. Hereinafter, this punching control is performed, depending on the calculated punching gap distance D1, by controlling the punch drive motor 102 with any one of three control systems of a temporary stop control, a motor acceleration/deceleration control, and a motor coarse/fine adjustment control. Judgement regarding which one of three control systems is chosen is made by the punching judgement unit 115.

In a case where the punching gap distance D1 is adequately large, the temporary stop control is performed. The temporary stop control is a control by which the rotational position of the punch 61 is temporarily stopped at the home position and the punch 61 is kept waiting until the succeeding sheet reaches the before-punch sensor 63.

The motor acceleration/deceleration control and the motor coarse/fine adjustment control are controls by which the punch 61 is basically not temporarily stopped and a rotational speed of the punch 61 is changed. In a case where the succeeding sheet has been already detected by the before-punch sensor 63 when the punching in the preceding sheet ends, the motor acceleration/deceleration control is performed, and, in a case where the succeeding sheet has not been detected by the before-punch sensor 63, the motor coarse/fine adjustment control is performed.

In this embodiment, at execution of the motor acceleration/deceleration control or the motor coarse/fine adjustment control, whether or not it is possible to perform the punching is judged by taking into consideration an acceleration/deceleration control capacity range of the punch drive motor 102. This judgment is made by the punching judgement unit 115 of the main control unit 101. Hereinafter, three control systems will be described in a sequential manner.

### Temporary Stop Control

At first, a case of performing the temporary stop control will be described. As shown in FIG. 5, the main control unit 101 judges whether or not the punching gap distance D1 calculated at STEP S3 is equal to or larger than 150 mm (STEP S4). Then, in a case where the punching gap distance D1 is equal to or larger than 150 mm (STEP S4: YES), the temporary stop control mentioned above is performed. A threshold value of 150 mm for the punching gap distance D1 is a value determined in this embodiment and to be determined corresponding to a distance between the before-punch sensor 63 and the punch 61, a configuration of the apparatus, specifications of the motor, and the like.

In this embodiment, operation specifications of the punch drive motor 102 are specified as: the sheet conveyance speed is 420 mm/sec; a rotational speed of the punch drive motor 102 which synchronizes with this sheet conveyance speed is 1000 pulses per second (pps); and an upper limit speed of the rotational speed of the punch drive motor 102 is 2100 pps. Further, in this embodiment, a lower limit speed of the rotational speed of the punch drive motor 102 is 500 pps, and an inclination of the punch drive motor 102 at a change of the speed is 1000 pps per 35 milli-seconds (msec). Further, a time required for the punch 61 to make one revolution corresponds to 250 steps as a number of the driving steps of the punch drive motor 102 which is constituted by a stepping motor.

When the punch 61 has ended the punching process in the preceding sheet, the rotational speed of the punch drive motor 102 (hereinafter referred to as a punching speed) is 1000 pps. Then, so as to temporarily stop the punch 61 at the home position in a minimum time under the conditions and configuration described above, at first the punch drive motor 102 is accelerated to 2100 pps which is the upper limit speed. Then, having maintained the upper limit speed of 2100 pps for a predetermined time, the punch drive motor 102 starts deceleration in a timing which enables the punch 61 to stop at the home position.

Thereafter, after a predetermined hold time has passed, the punch drive motor 102 resumes the drive to perform the punching process in the succeeding sheet. To be noted, the hold time is set at equal to or longer than 100 msec which is a required time to halt a vibration of the punch drive motor 102 constituted by the stepping motor. When the punch drive motor 102 is accelerated to 1000 pps which is the punching speed, the punch 61 punches the hole in the succeeding sheet.

In a case where these operations described above are performed within 250 steps which is the number of steps of one revolution of the punch 61, it is possible to calculate that at least 117.9 mm of the punching gap distance D1 is necessary. That is, in a case where the punching gap distance D1 is shorter than 117.9 mm, it is not possible to perform the temporary stop control. At this point, a threshold value used for the judgement of which one of the temporary stop control, or the motor acceleration/deceleration and motor coarse/fine adjustment controls is performed is referred to as a temporary stop judgement threshold value. In this embodiment, the temporary stop judgement threshold value is set at 150 mm to which a margin is added by taking into consideration a conveyance variance, a detection error, and the like. As described above, it is necessary to predetermine an appropriate temporary stop judgement threshold value in each case corresponding to a configuration of the apparatus and specifications of the motor drive.

Descriptions return to the flowchart shown in FIG. 5. In a case where it is judged that the punching gap distance D1 is equal to or longer than 150 mm (STEP S4: YES), the main control unit 101 controls the punch drive motor 102 so that the punch 61 temporarily stops at the home position (STEP S5). At this time, as described above, having been accelerated from 1000 pps to 2100 pps and held at the speed for the predetermined time, the punch drive motor 102 slows down so that the punch 61 stops at the home position. The home position of the punch 61 is a position where the punch HP sensor 69 detects the punch HP flag 70. Then, the main control unit 101 monitors the before-punch sensor 63 until the leading edge of the succeeding sheet is detected by the before-punch sensor 63 (STEP S6).

In a case where the leading edge of the succeeding sheet is detected by the before-punch sensor 63 (STEP S6: YES), the main control unit 101 judges whether or not it comes into a driving start timing of the punch drive motor 102 (STEP S7). This driving start timing is calculated by taking into consideration a distance from the leading edge of the succeeding sheet to the punch 61 at the engagement position, a time required to accelerate the punch drive motor 102 from a stopped state to the punching speed of 1000 pps, and the like. The main control unit 101 counts a time using the system timer 111 until it comes into the driving start timing.

In a case where it has come into the driving start timing (STEP S7: YES), the main control unit 101 starts driving the punch drive motor 102 so that the punch drive motor 102 is brought into the punching speed (STEP S8). Herewith, it is possible to punch the hole at the desired position in the succeeding sheet. As described above, in the case where the temporary stop control is performed, by appropriately setting the temporary stop judgement threshold value (150 mm in this embodiment), it is possible to punch the hole in any case, and a process to avoid punching the hole in the sheet, as described later, is not performed.

### Motor Acceleration/deceleration Control

Next, a case of performing the motor acceleration/deceleration control will be described. In a case where it is judged at STEP S4 that the punching gap distance D1 is shorter than 150 mm (STEP S4: NO), the punching judgement unit 115 of the main control unit 101 judges whether or not the succeeding sheet is detected by the before-punch sensor 63 (STEP S9). In a case where it is judged that the succeeding sheet is detected by the before-punch sensor 63 (STEP S9: YES), the succeeding sheet is approaching to the engagement position of the punch 61, and a variation of the subsequent sheet conveyance is at a negligible level.

Therefore, the main control unit 101 performs the motor acceleration/deceleration control which controls the acceleration and deceleration of the punch drive motor 102. In other word, in a case where the punching gap distance D1 is shorter than the temporary stop judgement threshold value of 150 mm and the succeeding sheet has reached the first detection position of the before-punch sensor 63, the motor acceleration/deceleration control is performed.

In the motor acceleration/deceleration control, the punch drive motor 102 is basically not temporarily stopped, and the punching at the desired punching gap distance is put into practice by controlling a rotational control of the punch drive motor 102. However, since the succeeding sheet is already in adjacent to the engagement position of the punch 61, it occurs in some cases that an adjustment exceeding a capacity range of the punch drive motor 102 is required and it is not possible to punch the hole at a desired position in the succeeding sheet. Therefore, in a case of proceeding to perform punching the hole at the desired position in the succeeding sheet, the punching judgement unit 115 of the main control unit 101 judges whether or not it is within a driving capacity range of the punch drive motor 102 and possible to punch the hole (STEP S10).

In a case where it is judged that punching the hole is possible (STEP S10: YES), the punch drive control unit 120 of the main control unit 101 performs the acceleration/deceleration control of the punch drive motor 102 (STEP S11), and ends the processes. On the other hand, in a case where it is judged that it is outside the driving capacity range of the punch drive motor 102 and punching the hole is not possible (STEP S10: NO), the punching judgement unit 115 controls the punch drive motor 102 so that the punch 61 stops at the home position (STEP S12).

Next, the judgement made at STEP S10 by the punching judgement unit 115 regarding whether or not it is possible to perform punching the hole will be described in detail with reference to FIG. 6A. At first, the punching gap distance calculation unit 113 of the main control unit 101 calculates a punching gap distance D2 from the positional information on the preceding and succeeding sheets based on the detection result of the before-punch sensor 63, and the information on the predetermined punching positions of the preceding and succeeding sheets (STEP S30). That is, the punching gap distance D2 is a gap distance, which is calculated from the detection result of the before-punch sensor 63, between the last punching position of the preceding sheet and the first punching position of the succeeding sheet in the sheet conveyance direction.

Next, the punching judgement unit 115 of the main control unit 101 judges whether or not the calculated punching gap distance D2 is within a capable range of the punching gap distance at which the punch drive motor 102 is capable of processing (STEP S31). In particular, the punching judgement unit 115 confirms that the calculated punching gap distance D2 is within the capable range of the punching gap distance shown in Table 1 below, at which the punch 61 is capable of punching the hole in one revolution (corresponding to 250 steps in terms of the number of driving steps of the punch drive motor 102).

TABLE 1

| | PUNCHING SPEED (SHEET |
|---|---|
| | CONVEYANCE SPEED) = |
| | 420 mm/sec |
| NUMBER OF | CAPABLE RANGE OF |
| ADJUSTMENT STEPS | PUNCHING GAP DISTANCE [mm] |
| 250 | 67.0 to 188.7 |

That is, in this embodiment, the punching judgement unit 115 judges at STEP S31 whether or not the punching gap distance D2 is within the range of equal to or larger than 67.0 and equal to or smaller than 188.7. Then, in a case where it is judged that the punching gap distance D2 is within the capable range (STEP S31: YES), the punching judgement unit 115 judges that it is possible to punch the hole (STEP S32). Further, in a case where it is judged that the punching gap distance D2 is outside the capable range (STEP S31: NO), the punching judgement unit 115 judges that it is not possible to punch the hole (STEP S33).

In a case where it is judged that it is possible to punch the hole, the punch drive control unit 120 controls the punch drive motor 102 by calculating a target speed and a timing to change the speed of the punch drive motor 102 so that the punch 61 makes one revolution (250 steps) in a time of the sheet conveyance corresponding to the punching gap distance D2.

### Motor Coarse/Fine Adjustment Control

Next, a case of performing the motor coarse/fine adjustment control will be described. The motor coarse/fine adjustment control, serving as a control mode, includes a motor coarse adjustment control (STEP S13), serving as a first process, and a motor fine adjustment control (STEP S17), serving as a second process. As shown in FIG. 5, in a case where it is judged at STEP S9 that the succeeding sheet is not detected by the before-punch sensor 63 (STEP S9: NO), the succeeding sheet has not yet approached the engagement position of the punch 61, and the position of the succeeding sheet is not detected accurately. However, it is in a state where the punching gap distance is not so large that it is necessary to temporarily stop the punch drive motor 102.

In the case as described above, the punching judgement unit 115 of the main control unit 101 performs the motor coarse/fine adjustment control (STEP S13). In the motor coarse/fine adjustment control, the punch drive motor 102 is controlled using the detection result of the inlet sensor 27 disposed upstream of the before-punch sensor 63 in the sheet conveyance direction. In particular, the acceleration and deceleration of the punch drive motor 102 are controlled using the punching gap distance D1 calculated based on the positional information on the succeeding sheet detected by the inlet sensor 27, namely the detection result of the inlet sensor 27.

As described above, the positional information on the succeeding sheet obtained by the inlet sensor 27, which is apart from the punch 61 to a certain extent, admits a subsequent occurrence of a conveyance variance, and is not the particularly accurate information. Therefore, after the motor coarse adjustment control, the motor fine adjustment control is performed based on more accurate information.

Since the motor fine adjustment control is performed subsequent to the motor coarse adjustment control, it is necessary to leave a certain number of steps to allot to the motor fine adjustment control, not allotting all of 250 steps, which are the number of steps required for the punch 61 to make one revolution, to the motor coarse adjustment control. In this embodiment, 170 steps are allotted to the motor coarse adjustment control, and remaining 80 steps are allotted to the motor fine adjustment control.

To be noted, as shown in Table 2 below, the number of steps allotted to the motor coarse adjustment control are not limited to 170 steps, and it is acceptable to allot any number of steps, and the punching gap distance which the motor coarse adjustment control is capable of processing varies depending on the number of steps allotted to the motor coarse adjustment control.

TABLE 2

| | PUNCHING SPEED (SHEET |
|---|---|
| | CONVEYANCE SPEED) = |
| | 420 mm/sec |
| | CAPABLE RANGE OF |
| NUMBER OF STEPS FOR | PUNCHING GAP DISTANCE |
| COARSE ADJUSTMENT | BY COARSE ADJUSTMENT [mm] |
| 250 | 67.0 to 188.7 |
| 230 | 72.2 to 178.2 |
| 210 | 76.5 to 169.4 |
| 190 | 81.0 to 160.7 |
| 170 | 85.4 to 151.9 |
| 150 | 89.7 to 143.1 |

Further, in this embodiment, when the motor coarse adjustment control ends, the rotational speed of the punch drive motor 102 is returned to 1000 pps, which is the punching speed. This is an arrangement whose purpose is to perform calculations of speed controls of the motor coarse adjustment control and the motor fine adjustment control relatively simply, and it is not always necessary to be returned to the punching speed. That is, it is acceptable to set the motor speed at a time of switching from the motor coarse adjustment control to the motor fine adjustment control at any speed.

In a case where there is not a variance in the sheet conveyance, the motor coarse adjustment control is performed during a time from the end of the punching process in the preceding sheet to an arrival of the leading edge of the succeeding sheet at the first detection position of the before-punch sensor 63. The motor fine adjustment control is performed during a time from the arrival of the leading edge of the succeeding sheet at the first detection position of the before-punch sensor 63 to an arrival of the leading edge of the succeeding sheet at a punching position, serving as a predetermined position of the punch 61. However, in a case where there is the variance in the sheet conveyance, for example, the motor coarse adjustment control ends before the arrival of the leading edge of the succeeding sheet at the first detection position of the before-punch sensor 63 after the end of the punching process in the preceding sheet.

The motor coarse adjustment control is configured to punch the hole at the desired position in the succeeding sheet in a case where, after the leading edge of the succeeding sheet has reached the first detection position, there is not the variance in the conveyance of the succeeding sheet and the speed of the punch drive motor 102 is maintained at 1000 pps without a change. For example, in the motor coarse adjustment control, having been accelerated to the target speed, the punch drive motor 102 is driven at the target speed for a predetermined time, and thereafter decelerated to the punching speed of 1000 pps.

Next, the motor fine adjustment control will be described. As shown in FIG. 5, the main control unit 101 monitors whether or not the motor coarse adjustment control has ended (STEP S14). In a case where the motor coarse adjustment control has ended (STEP S14: YES), the main control unit 101 monitors whether or not the leading edge of the succeeding sheet is detected by the before-punch sensor 63 (STEP S15).

In a case where the leading edge of the succeeding sheet is detected by the before-punch sensor 63 (STEP S15: YES), the punching judgement unit 115 of the main control unit 101 judges whether or not it is possible to punch the hole without exceeding the driving capacity range of the punch drive motor 102 (STEP S16). That is, the punching judgement unit 115 judges whether or not it is possible to punch the hole by adjusting the drive of the punch drive motor 102 so as to adjust the variance of the conveyance between the inlet sensor 27 and the before-punch sensor 63 again.

In a case where it is judged that it is possible to punch the hole (STEP S16: YES), the punch drive control unit 120 of the main control unit 101 performs the motor fine adjustment control (STEP S17), described later, and ends the processes. In the motor fine adjustment control, the punch drive motor 102 is controlled so that it is possible to punch the hole at the desired position in the succeeding sheet.

In a case where it is judged that it is outside the driving capacity range of the punch drive motor 102 and not possible to punch the hole (STEP S16: NO), the punching judgement unit 115 controls the punch drive motor 102 so that the punch 61 stops at the home position (STEP S18), and ends the processes.

Next, the judgement made at STEP S16 by the punching judgement unit 115 regarding whether or not it is possible to punch the hole will be described in detail with reference to FIG. 6B. The punching gap distance calculation unit 113 of the main control unit 101, at first, calculates the punching gap distance D2 from the positional information on the preceding and succeeding sheets based on the detection result of the before-punch sensor 63 and the information on the predetermined punching positions of the preceding and succeeding sheets (STEP S40).

Next, the punching judgement unit 115 judges whether or not a difference G between the punching gap distances D1 and D2 is inside a range of a correction distance (hereinafter referred to as an adjustable correction distance) which is adjustable by the number of steps allotted to the motor fine adjustment control (STEP S41). The difference G is obtained by subtracting D1 from D2. Further, the adjustable correction distance described above varies in accordance with the number of steps allotted to the motor fine adjustment control as shown in Table 3 below.

TABLE 3

| | PUNCHING SPEED (SHEET |
|---|---|
| | CONVEYANCE SPEED) = |
| | 420 mm/sec |
| | ADJUSTABLE CORRECTION |
| NUMBER OF STEPS FOR | DISTANCE BY FINE |
| FINE ADJUSTMENT | ADJUSTMENT [mm] |
| 0 | 0 |
| 20 | −1.0 to 1.5 |
| 40 | −3.3 to 9.4 |
| 60 | −6.3 to 18.1 |
| 80 | −9.9 to 26.9 |
| 100 | −13.8 to 35.7 |

Then, in a case where it is judged that the difference G is inside the range of the adjustable correction distance (STEP S41: YES), the punching judgement unit 115 judges that it is possible to punch the hole (STEP S42). Further, in a case where it is judged that the difference G is outside the range of the adjustable correction distance (STEP S41: NO), the punching judgement unit 115 judges that it is not possible to punch the hole (STEP S43).

In a case where it is judged that it is possible to punch the hole, the punch drive control unit 120 performs the motor fine adjustment control by calculating the target speed of the punch drive motor 102 and the timing of changing the speed so that the punch 61 makes one revolution (250 steps) in a time of the sheet conveyance corresponding to the punching gap distance D2. For example, in the motor fine adjustment control, having accelerated to the target speed, the punch drive motor 102 is driven at the target speed for a predetermined time, and thereafter decelerated to 1000 pps, which is the punching speed.

As described above, in this embodiment, when the succeeding sheet reaches the first detection position of the before-punch sensor 63, whether or not it is possible to punch the hole in the succeeding sheet is judged based on the punching gap distance D2 and the rotational position of the punch 61 (STEPS S10 and S16). In a case where it is judged that it is not possible to punch the hole in the succeeding sheet (STEPS S10 and S16: NO), the main control unit 101 performs an avoidance process to control the punch drive motor 102 so that the punch 61 stops at the home position (STEPS S12 and S18). That is, the main control unit 101 is capable of performing the avoidance process in the motor acceleration/deceleration control and the motor coarse/fine adjustment control. To be noted, at the home position, which is the rotational position, the punch 61 and the die 62 are disposed so as not to interrupt the sheet conveyed by the inlet roller pair 21. Further, the avoidance process has been completed before the leading edge of the succeeding sheet reaches the punching position of the punch 61.

In a case where the avoidance process has been performed, the succeeding sheet passes through the punch 61 and the die 62 in a state where the punch 61 and the die 62 are stopping at the home position. Therefore, the punching process in the succeeding sheet is avoided, and a low accuracy punching process not intended by a user is prevented. It is possible for the user to effectively use the sheet by separately carrying out the punching process to the sheet which has been discharged to the upper sheet discharge tray 25 or the lower sheet discharge tray 37 after provided with the avoidance process.

Further, in this embodiment, any one of the temporary stop control, the motor acceleration/deceleration control, and the motor coarse/fine adjustment control is performed depending on the punching gap distance D1 calculated at the end of the punching in the preceding sheet. In particular, in a case where the punching gap distance D1 is equal to or larger than the temporary stop judgement threshold value (150 mm), the temporary stop control is performed. Especially, in a case where the leading edge of the succeeding sheet is positioned upstream of the second detection position of the inlet sensor 27 in the sheet conveyance direction when the punching in the preceding sheet has ended, the temporary stop control is performed.

Further, in a case where the punching gap distance is smaller than the temporary stop judgement threshold value, the punch drive motor 102 is controlled by a different control depending on the position of the leading edge of the succeeding sheet. In particular, in a case where the leading edge of the succeeding sheet is positioned downstream of the first detection position of the before-punch sensor 63 in the sheet conveyance direction when the punching in the preceding sheet has ended, the motor acceleration/deceleration control is performed. In a case where the leading edge of the succeeding sheet is positioned between the second detection position of the inlet sensor 27 and the first detection position of the before-punch sensor 63 when the punching in the preceding sheet has ended, the motor coarse/fine adjustment control is performed.

Especially, in the motor acceleration/deceleration control and the motor coarse/fine adjustment control, it is possible to further reduce the sheet gap distance by accelerating and decelerating the punch drive motor 102, and possible to improve productivity. Further, in the motor coarse/fine adjustment control, since the acceleration/deceleration of the punch drive motor 102 is controlled in two steps of the motor coarse adjustment control and the motor fine adjustment control, it is possible to reduce an extent of the acceleration/deceleration, and possible to reduce a motor sound and contribute to energy conservation. Further, since the motor fine adjustment control is performed based on the detection result of the before-punch sensor 63 which is disposed in more adjacent to the punch 61 than the inlet sensor 27, it is possible to punch the hole in the sheet accurately. As described above, it is possible to provide the sheet processing apparatus reconciling punching accuracy with improved productivity, and the image forming system including this sheet processing apparatus.

### Second Embodiment

Although a second embodiment of this disclosure will be described next, the second embodiment is configured to perform the avoidance process by a method different from the first embodiment. Therefore, configurations similar to the first embodiment will be described by omitting illustrations or putting the same reference characters on diagrams.

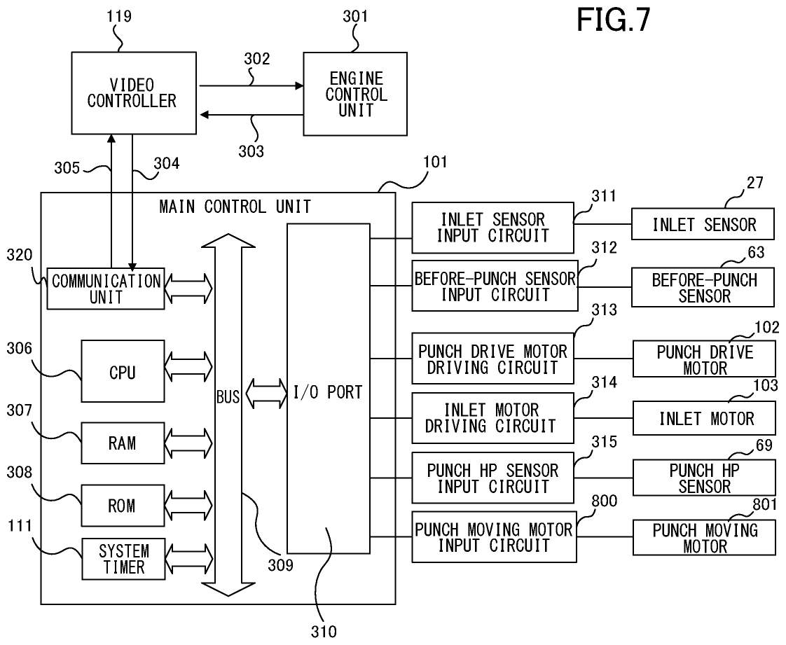

FIG. 7 is a block diagram showing a configuration of hardware of this embodiment. To be noted, FIG. 7 shows the configuration of the sheet processing apparatus 4 (refer to FIG. 1) primarily relating to a control of this embodiment, and the other configurations are omitted herein.

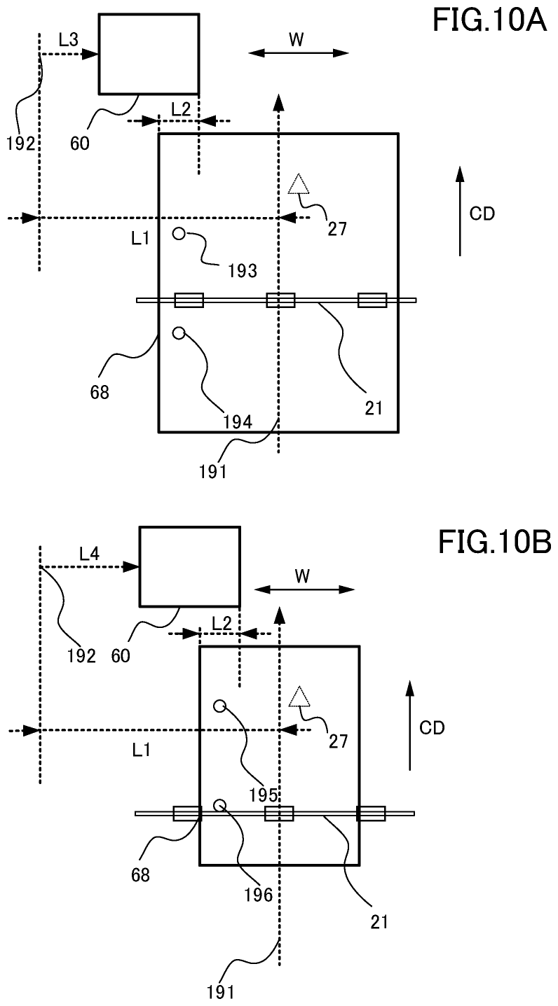

As shown in FIG. 7, the sheet processing apparatus 4 (refer to FIG. 1) of this embodiment includes, in addition to the configuration described in the first embodiment, a punch moving motor input circuit 800 and a punch moving motor 801, serving as a punch moving unit. The I/O port 310 is coupled to the punch moving motor 801 via the punch moving motor input circuit 800. As shown in FIGS. 10A and 10B, the punch moving motor 801 is capable of moving the punching apparatus 60 (refer to FIG. 1) in a width direction W orthogonal to the sheet conveyance direction CD, namely in a rotational axis direction of the punch 61 and the die 62.

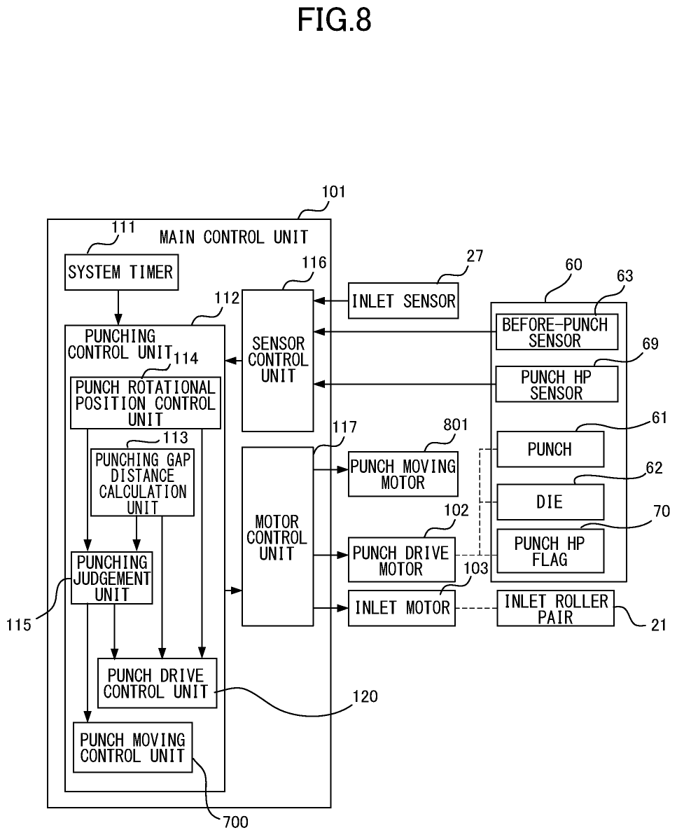

Further, FIG. 8 is a block diagram showing a configuration of functions of this embodiment. To be noted, FIG. 8 shows only portions extracted as primarily relating to the control of punching the hole in the sheet of this embodiment, and the other portions are omitted herein.

The punching control unit 112 includes a punch movement control unit 700 which controls the punch moving motor 801 via the motor control unit 117. The punch movement control unit 700 is capable of performing the avoidance process to move the punching apparatus 60 to a predetermined position in the width direction W by driving the punch moving motor 801 after having received the predetermined punching position information from the controller and before punching the hole in the sheet.

### Movement of Punching Apparatus

Next, movement of the punching apparatus 60 when the punching process in the sheet is performed will be described in detail using FIGS. 10A and 10B. FIGS. 10A and 10B are plan views showing the punching apparatus 60 and the sheet. Further, in FIGS. 10A and 10B, the punching apparatus 60 waits at an initial waiting position 192, for example, in a job in which the punching process is not performed. The initial waiting position is set at a position where the punch 61 and the die 62 of the punching apparatus 60 do not interrupt the conveyed sheet. Further, when performing the punching process in the sheet, the punching apparatus 60 moves in the width direction W so that the punching apparatus 60 approaches a conveyance path center line 191 from the initial waiting position 192.

In FIG. 10A, for example, an A4 size sheet is being conveyed, and in FIG. 10B, for example, an A5 size sheet is being conveyed. In a case where a size of the sheet in the width direction W is different, a moving distance from the initial waiting position 192 of the punching apparatus 60 varies. To be noted, a distance from the initial waiting position 192 to the conveyance path center line 191 is a distance L1.

As shown in FIG. 10A, when the punching process in the A4 size sheet is performed, the punching apparatus 60 moves by a distance L3 in the width direction W from the initial waiting position 192. Then, the punching apparatus 60 waits at a position which enters inside the sheet by a distance L2 in the width direction W, and punches a first hole 193 and a second hole 194 in the sheet.

Further, as shown in FIG. 10B, when the punching process in the A5 size sheet is performed, the punching apparatus 60 moves by a distance L4 in the width direction W from the initial waiting position 192. Then, the punching apparatus 60 waits at the position which enters inside the sheet by the distance L2 in the width direction W, and punches a first hole 195 and a second hole 196 in the sheet.

### Punching Control

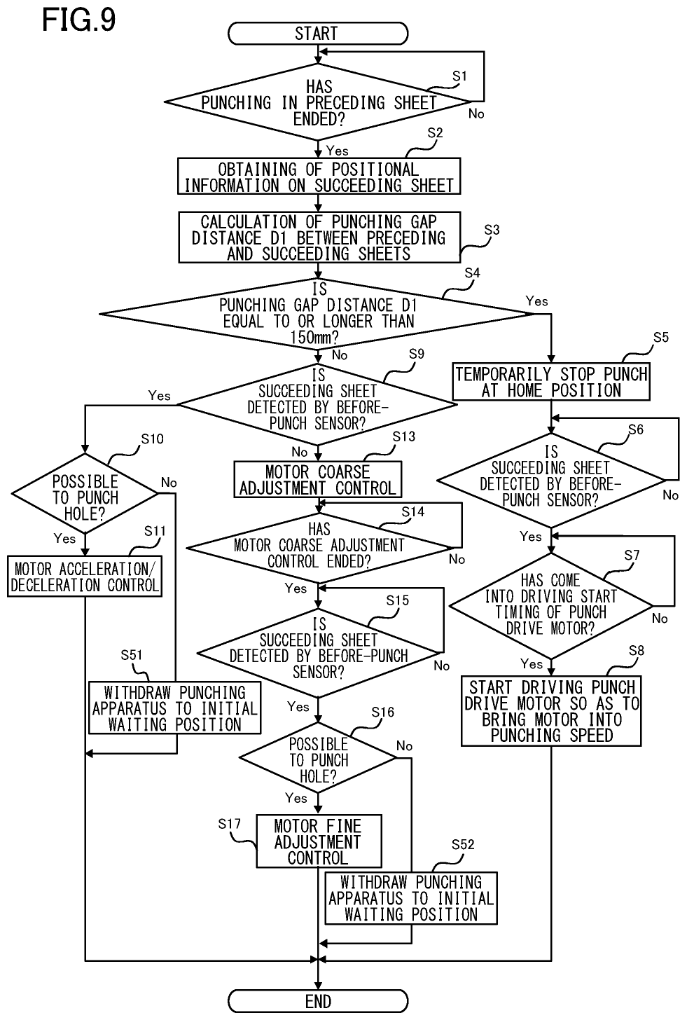

Next, with reference to FIGS. 9 to 10B, a punching control to punch the holes in a plurality of sheets in succession will be described. To be noted, this embodiment is different from the first embodiment at only STEPS S51 and S52 replacing STEPS S12 and S18 in the flowchart described in FIG. 5. Therefore, descriptions of the other steps will be omitted herein.

As shown in FIG. 9, in a case where it is judged that it is not possible to punch the hole (STEPS S10 and S16: NO), the punch movement control unit 700 performs the avoidance process so that the punching apparatus 60 including the punch 61 is withdrawn to the initial waiting position (STEPS S51 and S52). The withdrawal of the punching apparatus 60 to the initial waiting position is performed by controlling the punch moving motor 801. To be noted, the avoidance process has been completed before the leading edge of the succeeding sheet reaches the engagement position of the punch 61 of the punching apparatus 60.

As described above, in this embodiment, in a case where it is judged that it is not possible to punch the hole in the succeeding sheet (STEPS S10 and S16: NO), the main control unit 101 performs the avoidance process to withdraw the punching apparatus 60 to the initial waiting position (STEPS S12 and S18). To be noted, in a state where the punching apparatus 60 is positioned at the initial waiting position, the punch 61 and the die 62 are disposed at positions where the punch 61 and the die 62 do not overlap with the succeeding sheet in the width direction W so as not to interrupt the sheet conveyance.

In a case where the avoidance process has been performed, the succeeding sheet passes through a position not overlapping with the punch 61 and the die 62 in the width direction W by the inlet roller pair 21. Therefore, the punching process in the succeeding sheet is avoided, and a low accuracy punching process not intended by the user is prevented. It is possible for the user to effectively use the sheet by separately carrying out the punching process in the sheet which has been discharged to the upper sheet discharge tray 25 or the lower sheet discharge tray 37 after provided with the avoidance process.

### Alternatives to Embodiments

To be noted, although, in the first embodiment, the rotation of the punch 61 is stopped at the home position in the avoidance process, it is not limited to this. At this point, the punch 61 includes a first rotational range which is capable of interrupting with the sheet conveyed by the inlet roller pair 21, and a second rotational range which does not interrupt with the sheet conveyed by the inlet roller pair 21. The first rotational range includes the engagement position as shown in FIG. 2B, and, for example, is a rotational range from where the punch 61 starts to come into contact with the sheet to where the punch 61 is separated from the sheet. The second rotational range is a rotational range other than the first rotational range. Further, it is acceptable that, in the avoidance process, the main control unit 101 controls the punch drive motor 102 so that the punch 61 is passed through the first rotational range during a time after the trailing edge of the preceding sheet has passed through the punching position of the punch 61 and before the leading edge of the succeeding sheet reaches the punching position. In other words, the succeeding sheet passes through a rotational locus of the punch 61 without being punched during a time when the punch 61 is passing through the second rotational range. Herewith, the punching process in the succeeding sheet is avoided, and the low accuracy punching process not intended by the user is prevented. Further, it is acceptable to stop the punch 61 at any position inside the second rotational range, not limited to the home position.

Further, although in any of the embodiments described above, the position of the sheet is detected by two sensors of the inlet sensor 27 and the before-punch sensor 63, it is not limited to this. For example, it is acceptable to eliminate the inlet sensor 27, and, in this case, the main control unit 101 controls to accelerate and decelerate the punch drive motor 102 depending on the position of the succeeding sheet detected by the before-punch sensor 63.

Further, although, in any of the embodiments described above, descriptions are provided using the image forming apparatus 1 of the electrophotographic system, this disclosure is not limited to this. For example, it is possible to apply this disclosure to an image forming apparatus of the ink jet system which forms the image on the sheet by ejecting a liquid ink through a nozzle.

It is possible to put into practice this disclosure by supplying a program, which is capable of putting into practice equal to or more than one capability of the embodiments described above, to a system or an apparatus via a network or a storage medium, and by performing the processes with retrieving the program using equal to or more than one processor provided in the system or a computer of the apparatus. Further, it is also possible to put into practice this disclosure by a circuit, such as an application-specific integrated circuit (ASIC), which puts into practice equal to or more than one capability.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-042347, filed Mar. 11, 2020, which is hereby incorporated by reference herein in its entirety.

What is claimed is:

1. A sheet processing apparatus comprising:
a conveyance unit configured to convey a sheet in a sheet conveyance direction;
a punch member configured to be rotatably supported and punch a hole at a predetermined position in the sheet being conveyed by the conveyance unit;
a sensor configured to change an output value based on presence/absence of the sheet at a detection position positioned upstream of the punch member in the sheet conveyance direction;
a driving source configured to rotatably drive the punch member; and
a control unit configured to control the driving source,
wherein the control unit is configured to
(1) control the driving source based on a punching gap distance between a last punching position of a preceding sheet and a first punching position of a succeeding sheet in the sheet conveyance direction, and a rotational position of the punch member, and
(2) perform an avoidance process of avoiding a punching process of punching the hole in the succeeding sheet in a case where the control unit judges not to perform the punching process in the succeeding sheet based on the punching gap distance and the rotational position of the punch member when the succeeding sheet has reached the detection position.

2. The sheet processing apparatus according to claim 1, wherein, in the avoidance process, the control unit is configured to control the driving source such that the punch member is stopped at a rotational position where the punch member does not interrupt the sheet conveyed by the conveyance unit.

3. The sheet processing apparatus according to claim 2, further comprising a rotational position detection sensor configured to detect the rotational position.

4. The sheet processing apparatus according to claim 1, wherein the punch member comprises a first rotational range of being capable of interrupting the sheet conveyed by the conveyance unit and a second rotational range of not interrupting the sheet conveyed by the conveyance unit, and
wherein, in the avoidance process, the control unit is configured to control the driving source such that the punch member is passed through the first rotational range during a time after a trailing edge of the preceding sheet has passed through the predetermined position and before a leading edge of the succeeding sheet reaches the predetermined position.

5. The sheet processing apparatus according to claim 1, further comprising a punch moving unit configured to move the punch member in a rotational axis direction, of the punch member, orthogonal to the sheet conveyance direction,
wherein, in the avoidance process, the control unit is configured to control the punch moving unit so as to move the punch member to a position where the punch member does not overlap with the succeeding sheet in the rotational axis direction.

6. The sheet processing apparatus according to claim 1, wherein the control unit is configured to complete the avoidance process before a leading edge of the succeeding sheet reaches the predetermined position.

7. The sheet processing apparatus according to claim 1, wherein the sensor comprises a first sensor configured to change an output value based on presence/absence of the sheet at a first detection position,
wherein the sheet processing apparatus further comprises a second sensor configured to change an output value based on presence/absence of the sheet at a second detection position positioned upstream of the first detection position in the sheet conveyance direction,
wherein the control unit is configured to perform a control mode in a case where a leading edge of the succeeding sheet is positioned between the second detection position and the first detection position in the sheet conveyance direction when the punching process in the preceding sheet has ended, the control mode comprising a first process to control a rotational speed of the punch member based on a detection result of the second sensor, and a second process to control the rotational speed of the punch member based on a detection result of the first sensor.

8. The sheet processing apparatus according to claim 7, wherein the control unit is configured to perform the avoidance process after having performed the first process.

9. The sheet processing apparatus according to claim 7, wherein the control unit is configured to control the driving source such that a difference between the punching gap distance calculated based on the detection result of the second sensor and the punching gap distance calculated based on the detection result of the first sensor is corrected.

10. The sheet processing apparatus according to claim 7, wherein the control unit is configured to perform the second process without performing the first process in a case where the leading edge of the succeeding sheet is positioned downstream of the first detection position in the sheet conveyance direction when the punch member has ended the punching process in the preceding sheet.

11. The sheet processing apparatus according to claim 1, wherein the driving source is a stepping motor.

12. The sheet processing apparatus according to claim 1, further comprising:
a first conveyance path configured to receive the sheet;
a reverse portion configured to reverse the sheet received from the first conveyance path;
a stacking unit to stack the sheet reversed by the reverse portion;
a second conveyance path extending below the first conveyance path, and configured to receive the sheet reversed by the reverse portion and guide the sheet to the stacking unit;
a discharge unit configured to discharge the sheet outside the apparatus;
a third conveyance path extending toward the discharge unit from the stacking unit, and configured to guide the sheet to the discharge unit; and
a rotary member disposed on the second conveyance path, and configured to discharge the sheet to the stacking unit.

13. The sheet processing apparatus according to claim 12, wherein the punch member is disposed in the first conveyance path.

14. An image forming system comprising:
an image forming apparatus configured to form an image on a sheet; and
the sheet processing apparatus according to claim 1 configured to receive the sheet from the image forming apparatus.
